(19) United States
(12) Patent Application Publication
(10) Pub. No.: US 2007/0028203 A1
(43) Pub. Date: Feb. 1, 2007

(54) Apparatus and method for creating function verification description, and computer-readable recording medium in which program for creating function verification description is recorded

(75) Inventors: Mitsuru Sato, Kawasaki (JP); Hiroji Takeyama, Kawasaki (JP); Yuki Kumon, Kawasaki (JP); Tomoki Kanemochi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/258,176

(22) Filed: Oct. 26, 2005

(30) Foreign Application Priority Data
Jul. 28, 2005 (JP) 2005-219193

(51) Int. Cl. G06F 17/50

(52) U.S. Cl. 716/18; 716/4

(57) ABSTRACT

To create a function verification description, which is used for verifying a result of simulation performed on a finite state machine, irrespective of description languages of designing an FSM and creating the function verification description even by a person without knowledge of the language and the creation method of the function verification description, there is provided an apparatus including: an extracting section for extracting data concerning a performance that is a subject for the simulation from specification data of the FSM; a retaining section for retaining one or more description templates for function verification descriptions which are associated with one or more performances that are subjects for simulation; a selecting section for selecting a description template corresponding to the first performance; and a creating section for creating the function verifying description by substituting the data concerning the first performance into the particular description template selected.

### BACKGROUND OF THE INVENTION

1. Field of the Invention

The present invention relates to a technique to create a function verification description that is used for performance verification performed on an Finite State Machine (FSM) such as a logic circuit of a Large Scale Integration (LSI).

2. Description of the Related Art

For logic verification of a Finite State Machine (FSM) such as an LSI (Large Scale Integration), performance verification (performance confirmation) is carried out by simulation using a test pattern that is input to the FSM.

An FSM is a complex of states that can shift to other states responsive to inputs. Namely, an FSM can be in several finite states, and progresses from one state to another depending on the type of an input. For this reason, the result of performance verification can be obtained by simulating state transition in which the FSM is progresses to various receiving states (which can be generally considered as a complex of receiving states because the FSM usually has a number of destination states) from a single initial state responsive to inputs and finally reaches which state.

The result of the simulation is obtained in the form of a waveform signal. Since visual confirmation of the waveform by an operator (i.e., confirmation whether or not the result of the simulation is proper) requires cost and labor, conventional technique has been proposed that, concerning a part of items to be confirmed, a function verification description (hereinafter also called a checker) used for verification of the propriety of a simulation result (a waveform) is created and confirmation can be automatically carried out by the checker.

Specifically, such a checker is included in design data or a test bench, and confirms the result of simulation executed by a software simulator. If the checker finds abnormal performance concerning to the verification item, the checker automatically makes a report.

A checker has been generally written in HDL (Hardware Description Language) that is a circuit description language (i.e., a language used for FSM design).

In recent year, in view of efficiency, such a checker has come to be written in an assertion dedicated language developed with the intension of describing a verification item, not in HDL for circuit description.

Such an assertion dedicated language is exemplified by PSL (Property Specification Language) proposed by the “Formal Verification Technical Committee” (FVTC) of Accellera, the electronics industry organization focused on electronic design automation (EDA) standards, or SVA (System Verilog Assertion).

An assertion dedicated language creates a checker more efficiently than HDL. For example, a checker written in PSL has a description amount ⅕ to 1/10 of that written in HDL.

Conventionally, there have been proposed techniques of creating a verification description from a timing diagram (see below Patent Description 1 for example) and of automatically creating a checker written in HDL for list processing and parity check (see below Patent Description 2 for example). Concerning simulation on an FSM, there have been proposed techniques of automatically creating a test pattern (verification data) of simulation (see below Patent Description 3 for example) and of detecting insufficient test data to analyze a coverage (see below Patent Description 4 for example).

However, designer and verifier (hereinafter represented by the wording “designers”) of a circuit (an FSM) have to learn an assertion dedicated language (e.g., PSL or SVA) that has been newly developed in addition to a circuit description language. That loads much on the designers and a created checker is not reliable much until the designers fully attains a description manner using an assertion dedicated language.

Even if a checker is created by using HDL, the designers have to learn a manner for creating a checker, separately from a manner for designing an FSM.

[Patent Description 1] Japanese Patent Application Laid-Open (KOKAI) No. 2003-216683

[Patent Description 2] Japanese Patent Application Laid-Open (KOKAI) No. HEI 11-85821

[Patent Description 3] Japanese Patent Application Laid-Open (KOKAI) No. HEI 9-91315

[Patent Description 4] Published Japanese Translation of a PCT Application, No. 2002-514822

### SUMMARY OF THE INVENTION

With the foregoing problems in view, the object of the present invention is to create a function verification description (checker), which is used for verifying a result of simulation performed on an FSM, irrespective of languages for designing of an FSM and creating of a function verification description even by a person without knowledge of a creation manner of a function verification description.

In order to attain the above object, as a first generic feature, there is provided an apparatus for creating a function verification description which is used for verifying a result of simulation performed on a finite state machine, comprising an extracting section for extracting data concerning a performance that is a subject for the simulation from specification data of the finite state machine; a retaining section for retaining one or more description templates for function verification descriptions which description templates are associated with one or more performances that are subjects for simulation; a selecting section for selecting a particular description template corresponding to the first performance from the description templates retained in the retaining section; and a creating section for creating the function verifying description by substituting the data concerning the first performance, which data is extracted by the extracting section, into the particular description template selected by the selecting section.

As a preferable feature, the description templates retained in the retaining section may include a first description template for a function verification description used for verifying that the finite state machine progresses from a source state to a destination state under a proper condition; the extracting section may extract a source state, a transition condition and a destination state of the finite state machine from the specification data; the selecting section may select the first description template retained in the retaining section; and the creating section may create the first function verification description for verifying that the finite state machine progresses from a source state to a destination state under a proper condition by substituting the source state, the transition condition and the destination state that have been extracted by the extracting section into the first description template selected by the selecting section.

As another preferable feature, the description templates retained in the retaining section may include second description template for a second function verification description used for verifying that the finite state machine progresses from a source state to a destination state within a predetermined cycle set; the extracting section may extract a source state, a destination state, and a predetermined transition cycle set from the specification data; the selecting section may select the second description template retained in the retaining section; and the creating section may create the second function verification description for verifying that the finite state machine progresses from a source state to a destination state within a predetermined cycle set by substituting the source state, the destination state and the predetermined cycle set that have been extracted by the extracting section, into the second description template selected by the selecting section.

As a second generic feature, there is provided method for creating a function verification description which is used for verifying a result of simulation performed on a finite state machine, comprising the steps of: (a) extracting data concerning a performance that is a subject for the simulation from specification data of the finite state machine; (b) selecting a particular description template corresponding to the performance from one or more description templates for function verification descriptions which description templates are associated with one or more performances that are subjects for simulation; and (c) creating the function verifying description by substituting the data concerning the first performance, which data is extracted in the step (a) of extracting, into the particular description template selected in the step (b) of selecting.

As a third generic feature, there is provided a computer-readable recording medium in which a program for creating a function verification description which is used for verifying a result of simulation performed on a finite state machine, wherein the program instructs a computer to function as: an extracting section for extracting data concerning a performance that is a subject for the simulation from specification data of the finite state machine; a retaining section for retaining one or more description templates for function verification descriptions which description templates are associated with one or more performances that are subjects for simulation; a selecting section for selecting a particular description template corresponding to the first performance from the description templates retained in the retaining section; and a creating section for creating the function verifying description by substituting the data concerning the first performance, which data is extracted by the extracting section, into the particular description template selected by the selecting section.

According to the present invention, the extracting section extracts data concerning a performance that is a subject for the simulation from specification data of the finite state machine (FSM) (a step of extracting), the selecting section selects a description template corresponding to the performance (a step of selecting) and the creating section creates the function verifying description by substituting the data concerning the performance, which data is extracted by the extracting section, into said description template selected by the selecting section (a step of creating). In this method, a function verification description can be automatically created irrespective of description languages of the FSM specification data and the function verification description even if these languages are different. Additionally, if the function verification description is automatically created based on a description template, even a person even without knowledge of the language and the creation method of the function verification description can surely create a function verification description with ease.

Other objects and further features of the present invention will be apparent from the following detailed description when read in conjunction with the accompanying drawings.

### BRIEF DESCRIPTION OF THE DRAWINGS

FIG. 1 is a block diagram schematically showing a function verification description creating apparatus according to an embodiment of the present invention;

FIG. 2 is a state transition diagram of an FSM (Finite State Machine) that is an object for the function verification description creating apparatus of FIG. 1;

FIG. 3 is a diagram showing specification data of the FSM of FIG. 2;

FIG. 4 is a diagram showing transition timings which is a part of the specification data of the FSM of FIG. 2;

FIG. 5 is a diagram showing transition scenario which is a part of the specification data of the FSM of FIG. 2; and

FIGS. 6-9 are flow diagrams respectively showing exemplary successions of procedural steps for creating a function verification description according to an embodiment of the present invention.

### DESCRIPTION OF THE PREFERRED EMBODIMENTS

A preferred embodiment of the present invention will now be described with reference to the accompanying drawings.

### (A) An Embodiment

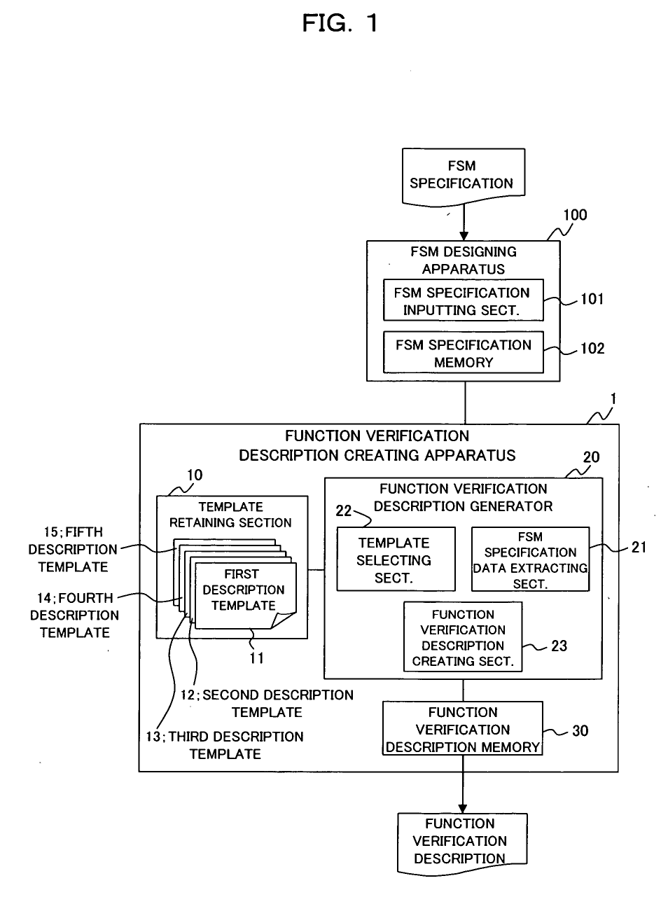

A function verification description creating apparatus according to an embodiment will now be described with reference to FIG. 1. As shown in FIG. 1, the function verification description creating apparatus 1 is connected to an FSM (Finite State Machine) designing apparatus 100, and includes a template retaining section (retaining section) 10, a function verification description generator 20, and a function verification description memory 30.

The FSM designing apparatus 100 designs an FSM using HDL (Hardware Description Language) or the like, and includes an FSM specification inputting section 101 used by a designer as inputting specification data of an FSM and an FSM specification memory 102 for retaining the specification data input via the FSM specification inputting section 101.

An FSM designer inputs the following data pieces (1) through (7) as specification data of an FSM via the FSM specification inputting section 101.

(1) all kinds of possible states of an FSM and an express manner of the states

(2) a transition path and a transition condition when an FSM progresses from one state to another state

(3) a transition condition (a common transition condition) common to all the states

(4) a transition timing at which an FSM progresses from one state to another state

(5) a state (an initial state) when a state transition starts

(6) a state (a receiving state) when a scenario of a state transition terminates

(7) a clock signal (name) and a reset signal (name)

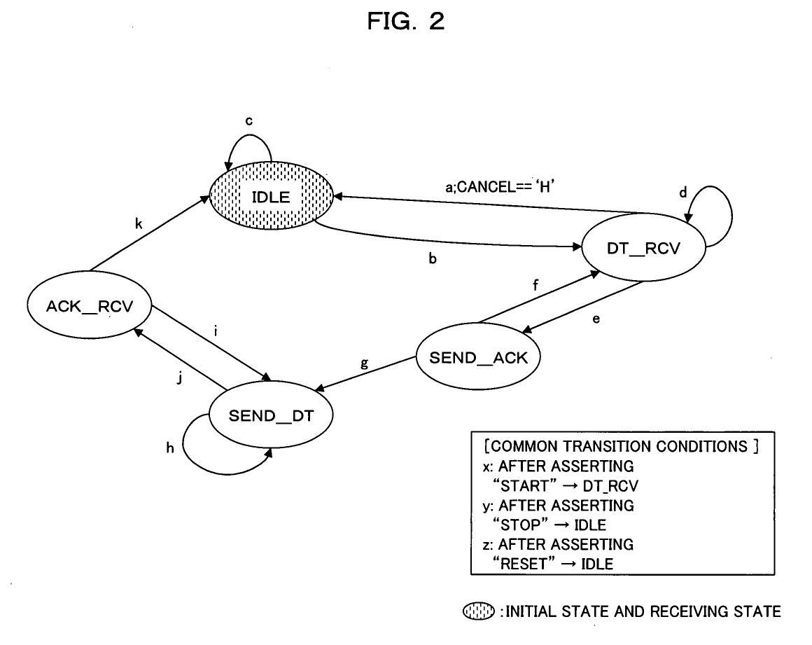

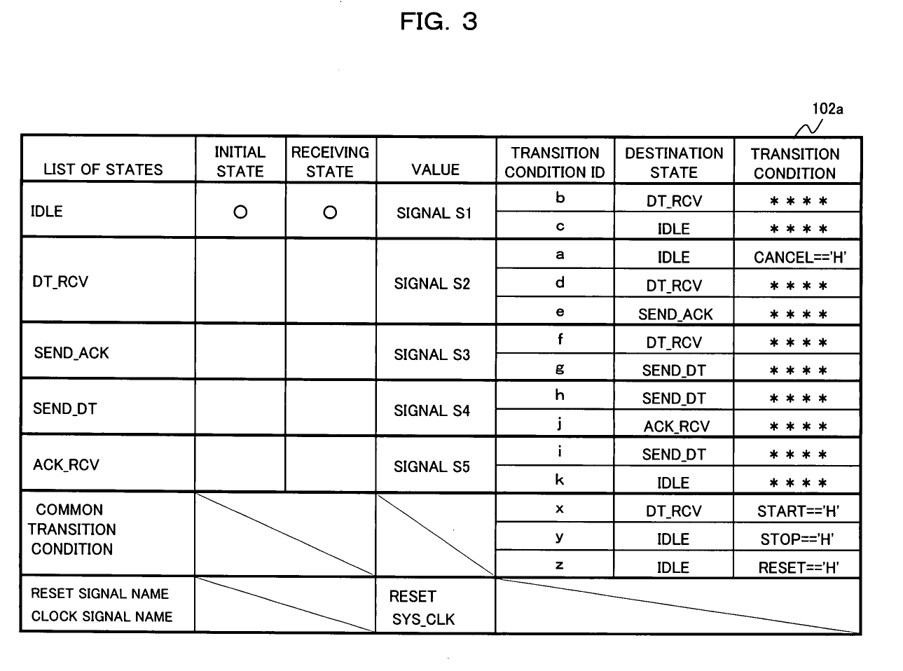

Here, FIGS. 2 and 3 show examples of the above items (1) to (7). Specifically, FIG. 2 is a state transition diagram of an FSM and FIG. 3 illustrates a data table in which specification data of the FSM of FIG. 2 is stored.

The state transition diagram of FIG. 2 and the data table 102a of FIG. 3 are retained in the FSM specification memory 102. In other words, all the above specification data pieces (1) to (7) input through the FSM specification inputting section 101 are retained in the FSM specification memory 102.

In the illustrated example, all the FSM state of “IDLE”, “DT_RCV”, “SEND_ACK”, “SEND_DT” and “ACK_RCV” are input for the specification data piece (1) by the FSM specification inputting section 101.

Here, “IDLE” represents a standby state; “DT_RCV” represents a data receiving state (DATA_RECEIVE); “SEND_ACK” represents an acknowledge sending state (SEND_ACKNOWLEDGE); “SEND_DT” represents a data sending state (SEND_DATA); and “ACK_RCV” represents an acknowledge receiving state (ACKNOWLEDGE_RECEIVE).

In order to express the above five states on hardware, there are proposed the below express manners (A) to (C), which FSM specification memory 102 should retain to be a part of the FSM specification data for function verification description creation.

(A) A number of 1-bit signals (e.g., signals S1-S5) are assigned one to each of the states.

For example, signal S1 is assigned to “IDLE” (“Signal S1 = IDLE”); and signals S2, S3, S4 and S5 are assigned to “DT_RCV”, “SEND_ACK”, “SEND_DT” and “ACK_RCV”, respectively.

(B) n-bit signals (where n is an integer) expressed by “State[2:0]” are assigned one to each of the states.

For example, “3′b000” is assigned to “IDLE”; and “3′b001”, “3′b010”, “3′b011” and “3′b100” are assigned to “DT_RCV”, “SEND_ACK”, “SENT_DT” and “ACK_RCV”, respectively.

(C) Bits of an n-bit signal expressed by, for example, “State[4:0]”, are assigned one to each of the state.

For example, “5′b00001” is assigned to “IDLE”; and “5′b00010”, “5′b00100”, “5′b01000” and “5′ b 10000” are assigned to “DT_RCV”, “SEND_ACK”, “SEND_DT” and “ACK_RCV”, respectively.

Such specification data piece (1) that has been input through the FSM specification inputting section 101 are stored in the FSM specification memory 102 based on an express manners exemplified by the above (A) to (C)).

The above specification data piece (2) that is to be input is transition paths between the states of the above data piece (1) and the transition conditions of the transition paths. Namely, arrows (transition paths) a-k which connects states (the arrows corresponding “transition condition IDs” in FIG. 3) and transition conditions of the transition paths a-k are input to be the specification data piece (2).

For example, the transition condition of transition path (transition condition ID) a of “CANCEL=H” shown in FIG. 3 represents a specification that “if a current state is “DT_RCV” and a CANCEL signal is “H”, the FSM progresses to “IDLE” in the next cycle (i.e., a source state: DT_RCV; a transition condition: CANCEL==“H”; and a destination state: IDLE)”.

For simplicity, the transition conditions of transition condition IDs b-k are omitted in FIG. 3 (expressed by “****” here).

For the above specification data piece (3), the FSM specification inputting section 101 inputs transition conditions common to all the state of the specification data piece (1), that is, common transition conditions irrespective of a current state of the FSM, and transition paths corresponding to the common transition conditions.

For example, common transition conditions expressed by transition condition IDs x-z are input into the FSM specification memory 102 as shown in FIG. 3. Here, a destination state and the transition condition of transition condition ID x are “DT_RCV” and “START== ‘H’”, respectively. Namely, the transition path x of this common transition condition indicates that if a START signal is asserted (i.e., becomes ‘H’), the FSM progresses a state of “DT_RCV” in the next cycle, irrespective of a current state.

The destination state and the transition condition of the transition condition ID y is “IDLE” and “STOP== ‘H’, respectively. Namely, the transition path y of the common transition condition indicates that if a STOP signal is asserted (i.e., becomes ‘H’), the FSM progresses to the state of “IDLE” in the next cycle, irrespective of a current state.

Further, concerning the transition condition ID z, the destination state and the transition condition thereof are “IDLE” and “RESET== ‘H’”, respectively. In other words, the transition path of the common transition condition z indicates that if a RESET signal is asserted (i.e., becomes ‘H’), the FSM progresses to the state of “IDLE” in the next cycle, irrespective of a current state.

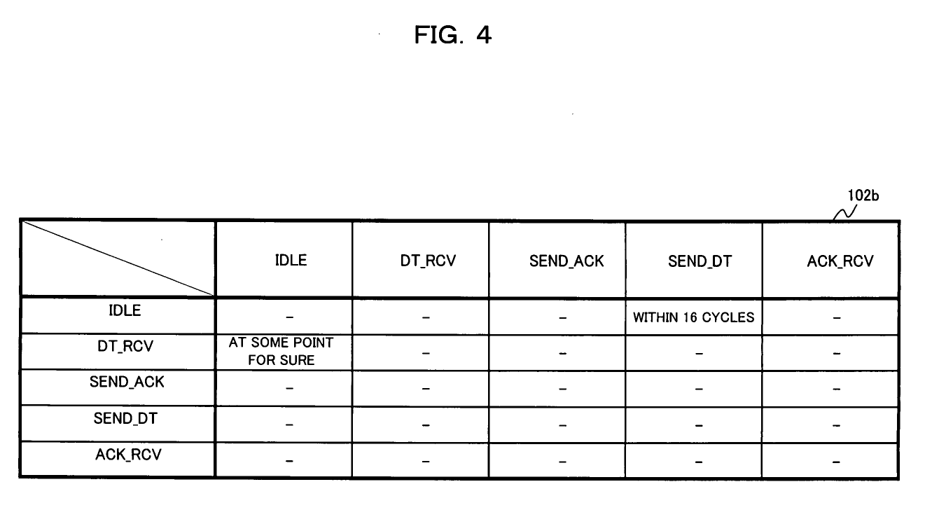

For the above specification data piece (4), there is input a transition timing, at which the FSM progresses from one state to another, as shown in a data table 102b of FIG. 4. The maximum value of the transition timing is the square of the number of all possible states of the FSM.

In the illustrated example, the state of “IDLE”, “within 16 cycles” and “SEND_DT” are input to be a state prior to transition (i.e., a source state), a transition timing, and a state after the transition (i.e., a destination state), respectively. This means that the FSM surely progresses from a source state “IDLE” to a destination state “SEND_DT” within a predetermined transition timing (within 16 cycles).

Here, the data table 102b further has input data of a state of “DT_RCV”, “at some point for sure” and a state of “IDLE” respectively for a source state, a transition timing and a destination state. This means that the FSM progresses from a source state “SEND_DT” to a destination state “IDLE” at some point for sure even through routed via another state.

Additionally, a state at the starting of a state transition of the FSM (i.e., the initial state) is input to be the above specification piece (5). In the illustrated example, the input initial state is the state of “IDLE” as shown in a data table 102a of FIG. 3.

Further, the specification data piece (6) is a state in which the FSM is at the end of a scenario of a state transition, that is, a receiving state. In this example, the state of “IDLE” is input to be a receiving state, as shown in the table 102a of FIG. 3.

For the specification data piece (7), a clock signal and a reset signal that are used in the FSM are input. In this example, “SYS_CLK” and “RESET” are input to be a clock signal name and a reset signal name, respectively.

The function verification description creating apparatus 1 creates a function verification description (a checker) that is used for verifying the result of simulation performed on the FSM on the basis of the specification data that has been input through the FSM specification inputting section 101 and that has been stored in the FSM specification memory 102 as described above.

Hereinafter, description will be now made in relation to the configuration of the function verification description creating apparatus 1 with reference to FIG. 1.

The template retaining section 10 retains one or more description templates for function verification descriptions associated with one or more performances that are subjects for simulation, and more particularly, retains five description templates of first description templates 11 through fifth description template 15 in this illustrated example. A description language and a state express manner (the above (A) to (C)) for each of the five templates 11 to 15 should by no means be limited in the function verification description creating apparatus 1 as long as the language and manner are identical to those of a function verification description that is to be created by the function verification description creating apparatus 1.

The first description template 11 is a template for a function verification description that is used for verification that the FSM progresses from a source state to a destination state under a proper condition and is represented by a function verification description that “if the FSM is in <source state> under <transition condition> and <reset signal is Off>, the FSM progresses to <destination state> after <transition timing>” brackets (< >) of which are blank.

The second description template 12 is a template for a function verification description that is used for verification that the FSM progresses from a source state to a destination state within a predetermined cycle set, in other words, for verification that state transition of the FSM is carried out at proper timings that the design specification determines. The second description template 12 is represented by a function verification description that “if <reset signal is off> and the FSM is in <source state>, the FSM progresses to <destination state> after <transition timing> brackets of which are blank.

The third description template 13 is a template for a function verification template that is used for verification that the FSM progresses from a source state to a predetermined destination state even through routed via another state, and is specifically represented by a function verification description that “when <a state transition from a source state initiates>, the FSM progresses to <predetermined destination state> at some point for sure” brackets of which are blank. In other words, the third description template 13 is a function verification description used for verification that a state transition designed to progress from a source state to a destination state at some point for sure, that is at an arbitrary timing is surely carried out.

The fourth description template 14 is a template for a function verification description used for verification that the FSM progresses from a source state to a predetermined destination state, in other words, verification that the FSM does not progress from a source state to states forbidden (i.e., states other than the predetermined destination state), and specifically is represented by a function verification description that “when the FSM <starts state transition from a source state>, the FSM progresses to <destination state> at some point for sure” brackets of which are blank. For example, focusing on an FSM state of “SEND_DT” in FIG. 2, transition paths the source state of which is the state of “SEND_DT” is a transition path b destined for a state of “ACK_RCV” and a transition path n destined for the same state “SEND_DT. Therefore, if the FSM progresses from the state of “SEND_DT to a state other than states of “ACK_RCV” and “SEND_DT, the FSM have a problem. The fourth description template is used for the detection of such a problem.

Specifically, the fourth description template 14 is represented by a function verification description that “the FSM progress from <arbitrary state> to one of <destination state 1>, <destination state 2>, . . . and <destination state n>” brackets of which are blank.

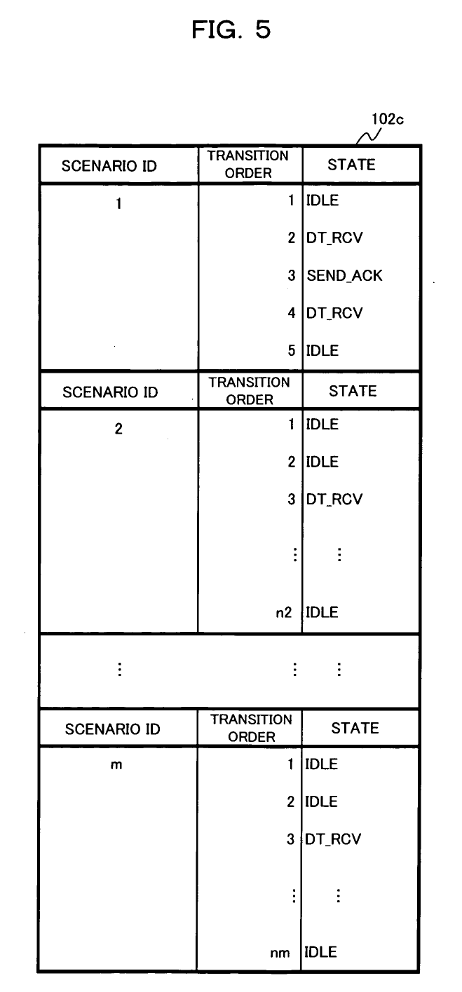

The fifth description template 15 is a template for a function verification description used for measurement of a coverage of a predetermined transition scenario that executes simulation. The fifth description template 15 is used for counting the number of occurrence of a transition scenario, and is a template for a function verification description for verification that a transition scenario (see FIG. 5 that is to be described later) predetermined by the designer is executed.

Physical and temporal restrictions make FSM simulation difficult to achieve 100% coverage. For this reason, measuring a coverage of a transition scenario generated as a result of simulation (i.e., the function verification description based on the fifth description template 15) provides an indicator for determination as to whether or not the simulation is adequate.

More specifically, the fifth description template 15 is a template for a function verification description used for verification that “if a state transition in order of <state 1>, <state 2>, . . . , <state n>, the simulation is true (executed)” brackets of which are blank.

The function verification description generator 20 creates a function verification description and includes an FSM specification data extracting section (extracting section) 21, a template selecting section (selecting section) 22 and a function verification description creating section (creating section) 23.

The FSM specification data extracting section 21 extracts data required for creating a function verification description, i.e., data concerning a performance that is a subject for simulation, from specification data (see FIGS. 2-4) of the FSM retained in the FSM specification memory 102.

The template selecting section 22 selects a description template associated with a function verification description that is to be created, that is, a description template associated with the performance that is the subject of the simulation, from the five description templates 11-15 retained in the template retaining section 10.

The function verification description creating section 23 substitutes the data concerning the performance of the simulation which data is extracted by the FSM specification data extracting section 21 into the description template associated with the performance of the same simulation which template is selected by the template selecting section 22 to thereby create a function verification description.

If the description of a description language and/or an express manner of the data extracted by the FSM specification data extracting section 21 are different from those of the description template selected by the template selecting section 22, the function verification description creating section 23 converts the description language and/or the express manner of the data extracted by the FSM specification data extracting section 21 into those of the selected description template based on a specification data concerning the express manner (A), (B) or (C) retained in the FSM specification memory 102. Such conversion of a description language and/or an express manner by the function verification description creating section 23 is carried out with reference to a table (not shown) indicates correlation of description languages of various types and/or with a table (not shown) indicates correlation of express manners of various types.

A function verification description created by the function verification description creating section 23 is retained in the function verification description memory 30 and is output to an external unit from the memory 30.

Here, examples of creation of a function verification description by the function verification description generator 20 will now be described.

At first, the function verification description generator 20 creates a function verification description used for verification that the FSM progresses to a source state to a destination state under a proper condition based on the first description template 11 retained in the template retaining section 10.

In this case, the FSM specification data extracting section 21 extracts a source state, a transition condition and a destination state from the specification data (see FIGS. 2 and 3) of the FSM which data is retained in the FSM specification memory 102.

In the meanwhile, the template selecting section 22 selects the first description template 11 from the first to the fifth description templates retained in the template retaining section 10.

The function verification description creating section 23 substitutes the source state, the transition condition and the destination state that have been extracted by the FSM specification data extracting section 21 into the first description template 11 to thereby create a function verification description for verification that the FSM progresses from a source state to a destinations state under a proper condition.

For example, description is made in relation to creation of a function verification description for a transition path a shown in FIGS. 2 and 3, in other words, to creation of a function verification description for verification a result of simulation whose subject is that state transition from a state of “DT_RCV” to a state of “IDLE” is carried out under a proper condition of “CANCEL== ‘H’”.

In this case, the FSM specification data extracting section 21 extracts “DT_RCV”, “CANCEL== ‘H’ ” and “IDLE” for a source state, a transition condition and a destination state, respectively, from the specification data in the FSM specification memory 102.

In the meanwhile, the template selecting section 22 selects the first description template 11 from the five description templates retained in the template retaining section 10.

The function verification description creating section 23 substitutes the data extracted by the FSM specification data extracting section 21 into the first description template 11 to thereby create a function verification description of, for example “always( {State == ‘DT_RCV && CANCEL && !SYS_RST } |=> {State ==‘DT_RCV; State ==‘IDLE}) @ (posedge SYS_CLK);”. This function verification description (i.e., the first description template 11) is described in PSL (Property Specification Language) of Verilog expression. In the illustrated example, the states are assumed to be expressed by bits of an n-bit signal assigned one to each of the states (i.e., in the above express manner (C)).

In creation of a function verification description based on the first description template 11, the function verification description generator 20 creates a function verification description for each of all the transition paths a-k and all the transition paths x-z with respect to the common transition conditions shown in FIGS. 2 and 3.

For this purpose, the FSM specification data extracting section 21 extracts all the state of the FSM, all the transition paths a-k and x-z, and transition conditions associated one with each of the transition paths a-k and x-z from the specification data, and the function verification description creating section 23 creates a function verification description for each of all the transition paths a-k and x-z based on the first description template 11.

At that time, the function verification description creating section 23 retains a creation flag for each of the transition paths a-k and x-z to indicate whether or not a function verification description for the transition path in question has been created, and sets the creation flag when the function verification description for the transition path is created. With reference to these creation flags, the function verification description creating section 23 surely creates function verification descriptions for all the transition paths a-k and x-z.

Next, description will now be made in relation to creation of a function verification description used for verifying that the FSM progresses from a source state to a destination state within a predetermined transition cycle set based on the second description template 12 in template retaining section 10 by the function verification description generator 20.

First of all, the FSM specification data extracting section 21 extracts a source state, a destination state and a predetermined transition cycles set from the specification data (see FIGS. 2-4) retained in the FSM specification memory 102.

In the meanwhile, the template selecting section 22 selects the second description template 12 from the five description templates retained in the template retaining section 10.

The function verification description creating section 23 creates a function verification description for verifying that the FSM progresses from a source state to a destination state within a predetermined transition cycle set by substituting the source state, the destination state and the predetermined cycle set extracted by the FSM specification data extracting section 21 in the second description template 12.

For example, description is made in relation to creation of a function verification description concerning a state transition within a transition cycle set having 16 cycles shown in FIG. 4, that is creation of a function verification description used for verifying a result of simulation that the FSM progresses from a state of “DT_RCV” to a state of “SEND_DT” “within 16 cycles”.

For this creation, the FSM specification data extracting section 21 extracts a state of “DT_RCV”, a state of “SEND_DT”, “within 16 cycles” to be a source state, a destination state and a predetermined transition cycle set.

In the meanwhile, the template selecting section 22 selects the second description template 12 from the five description templates in the template retaining section 10.

The function verification description creating section 23 then substitutes data extracted by the FSM specification data extracting section 21 into the second description template 12 to create a function verification description exemplified by “always (({State == ‘IDLE }} |=>{true[* ..15]; State == ‘SEND_DT}) abort RESET) @ (posedge SYS_CLK);”. This function verification description (i.e., the second description template 12) is described in PSL (Property Specification Language) of Verilog expression. In the illustrated example, the states are assumed to be expressed by bits of an n-bit signal assigned one to each of the states (i.e., in the above express manner (C)).

In creation of a function verification description based on the second description template 12, the function verification description generator 20 creates function verification descriptions for each of all the predetermined transition cycle sets shown in FIG. 4 (in the illustrated example, a single cycle set).

For this purpose, the FSM specification data extracting section 21 extracts all the predetermined transition cycle sets, and a source state and a destination state associated with each of all the predetermined transition cycle sets from the specification data, and the function verification description creating section 23 creates a function verification description for each of all the predetermined transition cycle sets based on the second description template 12.

At that time, the function verification description creating section 23 retains a creation flag for each of all the predetermined transition cycle sets to indicate whether or not a function verification description for the function verification description for the predetermined transition cycle set in question has been created, and sets the creation flag when a function verification description for the predetermined transition cycle set is created. With reference to these creation flags, the function verification description creating section 23 surely creates function verification descriptions for all the predetermined transition cycle sets.

In succession, description will now be made in relation to creation of a function verification description used for verifying that the finite state machine progresses from a source state to a predetermined destination state even though routed via another state based on the third description template 13 by the function verification description generator 20.

At the beginning, the FSM specification data extracting section 21 extracts an assignation information piece (in this example, information of “at some point for sure” in FIG. 4) for assigning a source state and a destination state from the specification data (see FIGS. 2-4) retained in the FSM specification memory 102 to thereby obtain the source state and the predetermined destination state.

In the meanwhile, the template selecting section 22 selects the third description template 13 from the five description templates in the template retaining section 10.

Then the function verification description creating section 23 substitutes the source state, and the destination state in the third description template 13 to create a function verification description used for verifying that the FSM progresses from a source state to a predetermined state even through routed via another state.

For example, description is made in relation to creation of a function verification description concerning an assignation information piece “some point for sure”, that is, creation of a function verification description for verifying a result of simulation that the FSM progresses from a predetermined source state of “DT_RCV” to a predetermined destination state of “IDLE” at some point for sure even through routed via another state.

In this case, the FSM specification data extracting section 21 extracts “some point for sure”, a state of “DT_RCV”, a state of “IDLE” to be an assignation information piece, a source state, and a destination state, respectively.

In the meanwhile, the template selecting section 22 selects the third description template 13 from the five description templates in the template retaining section 10.

The function verification description creating section 23 then substitutes the data extracted by the FSM specification data extracting section 21 into the third description template 13 to create a function verification description exemplified by “always ( (State == ‘DT_RCV) −> next everntually! (State == ‘IDLE) ) @ (posedge SYS_CLK);”. This function verification description (i.e., the third description template 13) is described in PSL (Property Specification Language) of Verilog expression. In the illustrated example, the states are assumed to be expressed by bits of an n-bit signal assigned one to each of the states (i.e., in the above express manner (C)).

In creation of a function verification description based on the third description template 13, the function verification description generator 20 creates a function verification description for each of all the assignation information pieces (in the illustrated example, a single information piece) shown in FIG. 4.

For this purpose, the FSM specification data extracting section 21 extracts all the assignation information pieces, the source state and the destination states associated with all the assignation information pieces, and the function verification description creating section 23 creates a function verification description for each of all the assignation information pieces.

The function verification description creating section 23 retains a creation flag for each of all the assignation information pieces to indicate whether or not a function verification description for the assignation information piece in question has been created, and sets the creation flag when a function verification description for the assignation information piece is created. With reference to these creation flags, the function verification description creating section 23 surely creates function verification descriptions for all the assignation information pieces.

Further, description will now be made in relation to a creation, by the function verification description generator 20, of a function verification description used for verifying that the FSM progresses from a source state to a predetermined destination state based on the fourth description template 14 retained in the template retaining section 10.

In this case, the FSM specification data extracting section 21 extracts a source state and a predetermined destination state associated with the source state from the specification data (see FIGS. 2 and 3) retained in the FSM specification memory 102.

In the meanwhile, the template selecting section 22 selects the fourth description template 14 from the five description templates retained in the template retaining section 10.

The function verification description creating section 23 substitutes the source state and the predetermined destination state associated with the source sate, which states have been extracted by the FSM specification data extracting section 21, into the fourth description template 14 to thereby create a function verification description for verifying that the FSM progresses from a source state to a predetermined destination state.

For example, description will now be made in relation to creation of a function verification description for a state of “SEND_DT” shown in FIGS. 2 and 3, more specifically, creation of a function verification description for verifying a result of simulation that the FSM carries out a state transition from a state of “SEND_DT” to a state of “ACK_RCV” or “SEND_DT”.

First of all, the FSM specification data extracting section 21 extracts a state of “SEND_DT” and states of “ACK_RCV” and “SEND_DT” to be a source state and destination states, respectively.

In the meanwhile, the template selecting section 22 selects the fourth description template 14 from the five description templates in the template retaining section 10.

The function verification description creating section 23 substitutes data extracted by the FSM specification data extracting section 21 into the fourth description template 14 to create a function verification description exemplified by “always ( (State == ‘SEND_DT) −> next (State == ‘SEND_DT ∥ State == ‘ACK_RCV ) ) @ (posedge SYS_CLK);”. This function verification description (i.e., the fourth description template 14) is described in PSL (Property Specification Language) of Verilog expression. In the illustrated example, the states are assumed to be expressed by bits of an n-bit signal assigned one to each of the states (i.e., in the above express manner (C)).

In creation of a function verification description based on the fourth description template 14, the function verification description generator 20 creates a function verification description for each of all the states shown in FIGS. 2 and 3, regarding each state as a source state.

For this purpose, the FSM specification data extracting section 21 extracts all the state of the FSM and one or more destination states associated with each of all the states from the specification data, and the function verification description creating section 23 creates a function verification description for each of all the states based on the fourth description template 14.

In this case, the function verification description creating section 23 retains a creation flag for each of all the states to indicate whether or not a function verification description for the sate in question has been created, and set the creation flag when a function verification description for the state is created. With reference to these creation flags, the function verification description creating section 23 surely creates function verification descriptions for all the states.

Still further, description will now be made in relation to creation, based on the fifth description template 15 retained in the template retaining section 10, of a function verification description used for measuring a coverage of a predetermined scenario that executes simulation by the function verification description generator 20.

In this case, the FSM specification data extracting section 21 extracts data concerning a predetermined transition scenario from, for example, a data table 102c shown in FIG. 5 serving as the specification data retained in the FSM specification memory 102.

Here, the data table 102c shown in FIG. 5 concerns predetermined transition scenarios for performances that are subject of simulation that the designer has input via the FSM specification inputting section 101, and retains an transition order and states, one associated with each stage of the order, for each scenario ID.

In the meanwhile, the template selecting section 22 selects the fifth description template 15 from the five description templates in the template retaining section 10.

The function verification description creating section 23 substitutes the states of the transition scenario extracted by the FSM specification data extracting section 21 into the fifth description template 15 based on the order of the sates to create a function verification description for verifying a coverage.

Description will now be made in relation to creation of a function verification description for a transition scenario of a state transition “IDLE”→“DT_RCV”→“SEND_ACK”→“DT_RCV”→“IDLE”, corresponding to scenario ID “1” in the data table 102c of FIG. 5 for the FSM of FIGS. 2 and 3.

The FSM specification data extracting section 21 extracts a state transition of “IDLE”→“DT_RCV”→“SEND_ACK”→“DT_RCV”→“IDLE” to be a predetermined transition scenario from the specification data (see FIG. 5) in the FSM specification memory 102.

In the meanwhile, the template selecting section 22 selects the fifth description template 15 from the five description template in the template retaining section 10.

Then the function verification description creating section 23 substitutes the transition scenario extracted by the FSM specification data extracting section 21 into the fifth description template 15 to create a function verification description exemplified by “always ({State ==‘IDLE; State == ‘DT_RCV; State == ‘SEND_ACK; State ==‘DT_RCV; State == ‘IDLE} |−>{true}) @ (posedge SYS_CLK);”. This function verification description (i.e., the fifth description template 15) is described in PSL (Property Specification Language) of Verilog expression. In the illustrated example, the states are assumed to be expressed by bits of an n-bit signal assigned one to each of the states (i.e., in the above express manner (C)).

In creation of a function verification description based on the fifth description template 15, the function verification description generator 20 creates a function verification description for each of all the transition templates shown in FIG. 5.

The FSM specification data extracting section 21 extracts all the transition scenarios retained in the specification data from the specification data, and the function verification description creating section 23 creates a function verification description for each of all the transition scenarios based on the fifth description template 15.

The function verification description creating section 23 retains a creation flag for each of all the transition scenarios to indicate whether or not a function verification description for the transition scenario in question has been created, and sets the creation flag when the function verification description for the transition scenario is created. With reference to these creation flags, the function verification description creating section 23 surely creates function verification descriptions for all the transition scenarios.

Subsequently, description will now be made in relation to a method for creating a function verification description (a succession of procedural steps perfomed by the function verification description creating apparatus 1) for each of the first to fifth description templates 11-15 retained in the template retaining section 10.

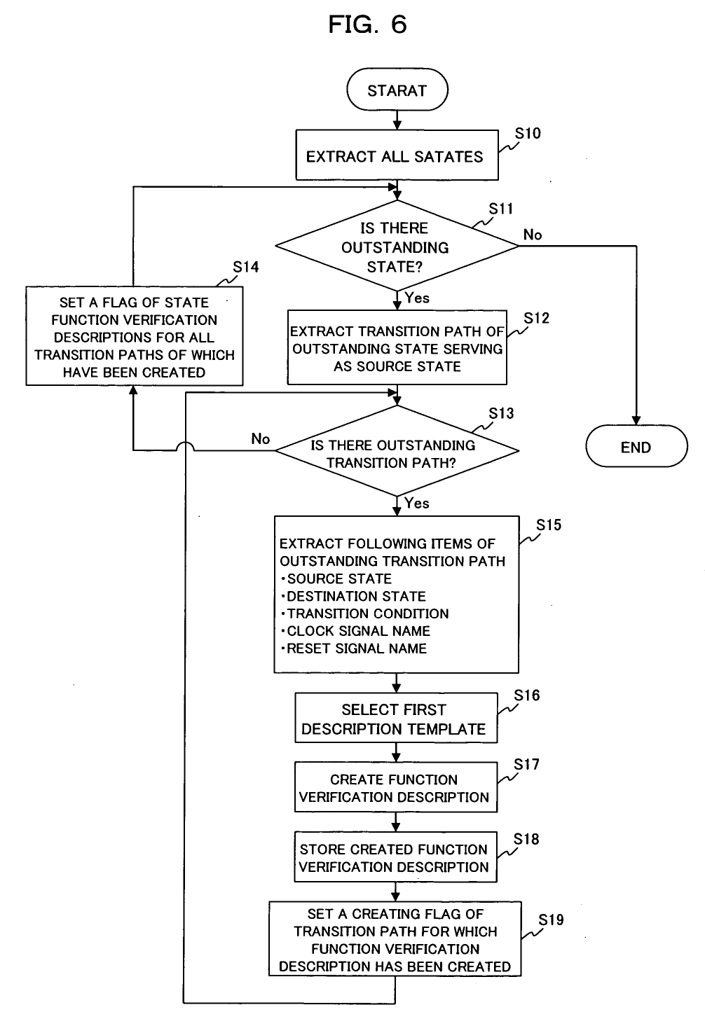

Here, description will now be made in relation to creation of a function verification description based on the first description template 11 with reference to flow diagram FIG. 6 (steps S10-S19).

First of all, the FSM specification data extracting section 21 of the function verification description generator 20 extracts all the possible states of the FSM from the specification data retained in the FSM specification memory 102 (step S10). In this example, states of “IDLE”, “DT_RCV”, “SEND_ACK”, “SEND_DT”, and “ACK_RCV” shown in FIGS. 2 and 3 are extracted.

In succession, the function verification description creating section 23 judges whether or not there is an outstanding state (step S11). The function verification description creating section 23 of this embodiment retains a creation flag for each state extracted in step S10 to indicate whether or not function verification descriptions for all the transition paths associated with the state in question have been created. In step S11, the function verification description creating section 23 judges whether or not there is a flag which is not set.

If the result of the judgment by the function verification description creating section 23 is negative (in other words, there is no state creation flag of which is not set) (No route in step S11), the succession of the procedural steps terminates.

On the other hand, if the result of the judgment by the function verification description creating section 23 is positive (in other words, there is a state creation flag of which is not set) (Yes route in step S11), the FSM specification data extracting section 21 extracts one or more transition paths the source state of which is the judged outstanding state from the specification data retained in the FSM specification memory 102 and also extracts transition condition of the extracted transition paths from the specification data (step S12; a step of extracting). At that time, the FSM specification data extracting section 21 extracts transition paths on the basis of the common transition conditions.

The function verification description creating section 23 judges whether or not there is an outstanding transition path (in other words, whether or not a transition path is extracted in previous step S12) (step S13). If the result of the judgment in step S13 is negative (in other words, no transition path is extracted in step S12) (No router in step S13), the function verification description creating section 23 sets a creation flag of the outstanding state (a state function verification descriptions for all transition paths of which have been created) and returns to step S11.

Conversely, if the result of judgment in step S13 is positive (in other words, a transition path is extracted in step S12) (Yes route in step S13), the FSM specification data extracting section 21 extracts data (here, a source state, a destination state, a transition condition, a clock signal name and a rest signal name) associated with the outstanding transition path from the specification data retained in the FSM specification memory 102 (step S15, a step of extracting).

Subsequently, the template selecting section 22 selects the first description template 11 from the five description templates retained in the template retaining section 10 (step S16, a step of selecting).

The function verification description creating section 23 substitutes the data extracted by the FSM specification data extracting section 21 in step S15 into the first description template 11 selected by the template selecting section 22 in step S16 to create a function verification description (step S17, a step of creating).

Further, the function verification description creating section 23 stores the function verification description created in step S17 into the function verification description memory 30 (step S18), sets the creation flag associated with the the transition path (step S19) and returns to step S13.

The function verification description generator 20 repeats the above procedural steps S11 through S19 whereby creates function verification descriptions for all the transition paths (i.e., transition paths a-k and x-y shown in FIGS. 2 and 3) of the specification data retained in the FSM specification memory 102.

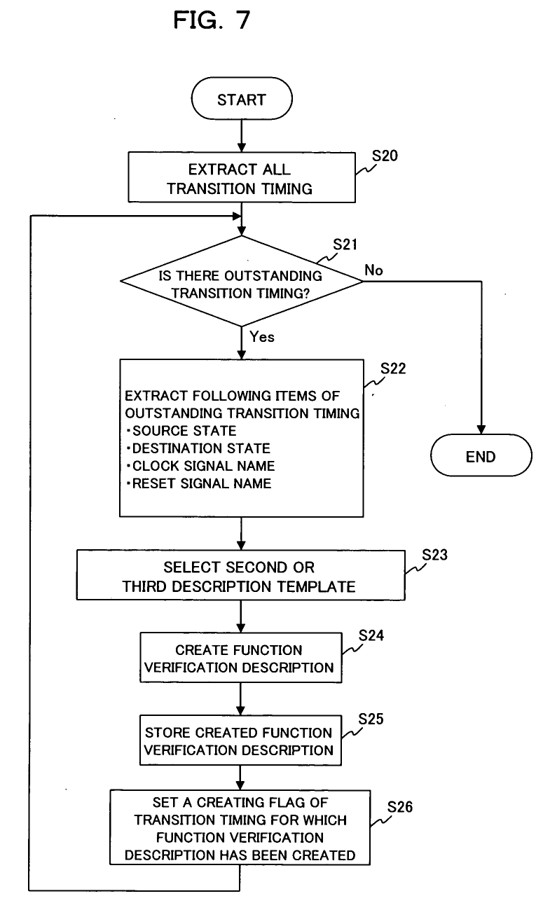

Next, description is made in relation to creation of a function verification description based on the second description template 12 or the third description template 13 with reference to flow diagram FIG. 7 (steps S20-S26).

First of all, the FSM specification data extracting section 21 of the function verification description generator 20 extracts all the transition timing (all the predetermined transition cycle sets and all the assignation information pieces) from the specification data (see FIG. 4) retained in the FSM specification memory 102 (step S20, a step of extracting). In the illustrated example, a predetermined cycle set of “within 16 cycles” and an assignation information piece of “at some point for sure” are extracted from the specification data.

The function verification description creating section 23 then judges whether or not there is an outstanding transition timing (step S21). Namely, the function verification description creating section 23 judges, based on a creation flag of each of all the transition timing extracted in step S20, whether or not there is an outstanding transition timing.

Here, if the result of the judgment in step S21 is negative (in other words, there is no transition timing the creation flag of which is not set) (No route in step S21), the succession of the procedural steps terminates.

On the other hand, if the result of the judgment is positive (in other words, there is a transition timing the creation flag is not set) (Yes route in step S21), the FSM specification data extracting section 21 extracts data (in this example, a transition state, a destination state, a clock signal name, and a reset signal name) associated with the outstanding transition timing from the specification data retained in the FSM specification memory 102 (step S22, a step of extracting).

The template selecting section 22 selects the second description template 12 or the third description template 13 from the five description templates retained in the template retaining section 10 (step S23, a step of selecting).

Specifically, the template selecting section 22 selects the second description template 12 if the outstanding transition timing is a predetermined transition cycle set and selects the third description template 13 if the outstanding transition timing is an assignation information piece.

The function verification description creating section 23 substitutes the data extracted by the FSM specification data extracting section 21 in step S22 into the description template selected by the template selecting section 22 in step S23 to create a function verification description (step S24, a step of creating).

Then the function verification description creating section 23 stores the function verification description created in step S24 into the function verification description memory 30 (step S25), sets the creating flag associated with the transition timing for which the function verification description is created (step S26) and returns to step S21.

The function verification description generator 20 repeats the above procedural steps S21 through S26 whereby creates function verification descriptions for all the transition timings (see FIG. 4) of the specification data retained in the FSM specification memory 102.

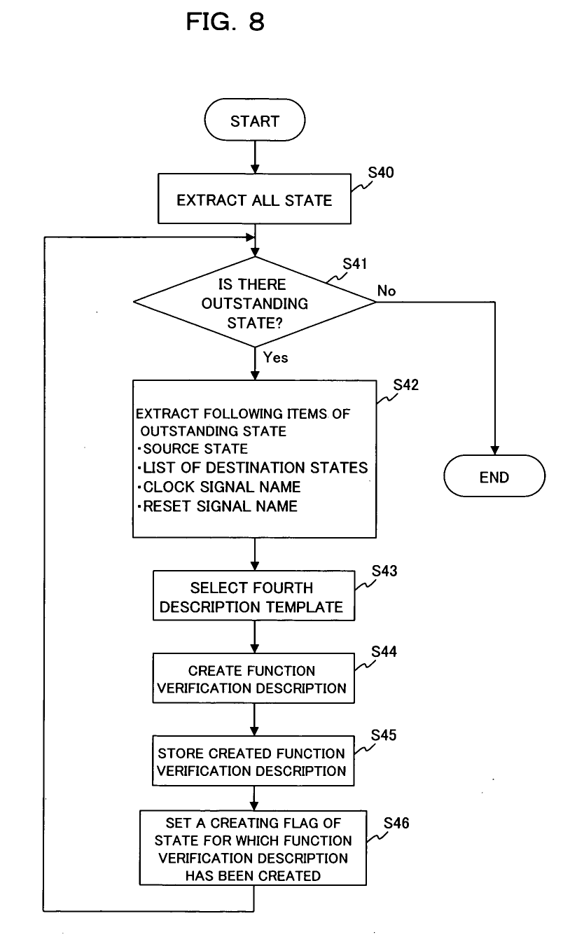

Here, description is made in relation to creation of a function verification description based on the fourth description template 14 with reference to flow chart FIG. 8 (steps S40-S46).

First of all, the FSM specification data extracting section 21 of the function verification description generator 20 extracts all the states of the FSM from the specification data retained in the FSM specification memory 102 (step S40, a step of extracting). In the illustrated example, states of “IDLE”, “DT_RCV”, “SEND_ACK”, “SEND_DT”, and “ACK_RCV” are extracted.

The function verification description creating section 23 judges whether or not there is an outstanding state (step S41). More specifically, the function verification description creating section 23 retains a creation flag for each of all the states extracted in step 40 to indicate whether or not a function verification description for the state regarded as a source state has been created, and judges whether or not the creation flag is set.

If the result of the judgment is negative (in other words, there is no state the creation flag of which is not set) (No route in step S41), the succession of the procedural steps terminates.

On the other hand, if the result of the judgment is positive (in other words, there is state the creation flag of which is not set) (Yes route in step S41), the FSM specification data extracting section 21 extracts data (in this example, a source state, a list of destination states of the source state in question, a clock signal name, and a reset signal name) concerning a transition path whose source state is the outstanding state from the specification data retained in the FSM specification memory 102 (step S42, a step of extracting).

In succession, the template selecting section 22 selects the fourth description template 14 from the five description templates in the template retaining section 10 (step S43, a step of selecting).

The function verification description creating section 23 substitutes data extracted by the FSM specification data extracting section 21 in step S42 into the fourth description template 14 selected by the template selecting section 22 in step S43 to create a function verification description (step S44, a step of creating).

The function verification description creating section 23 further stores the function verification description created in step S44 into function verification description memory 30 (step S45), set the flag of the state for which a function verification description is created (step S46) and returns to step S41.

The function verification description generator 20 repeats the above procedural steps S41 through S46 whereby creates function verification descriptions for all the states of the specification data retained in the FSM specification memory 102.

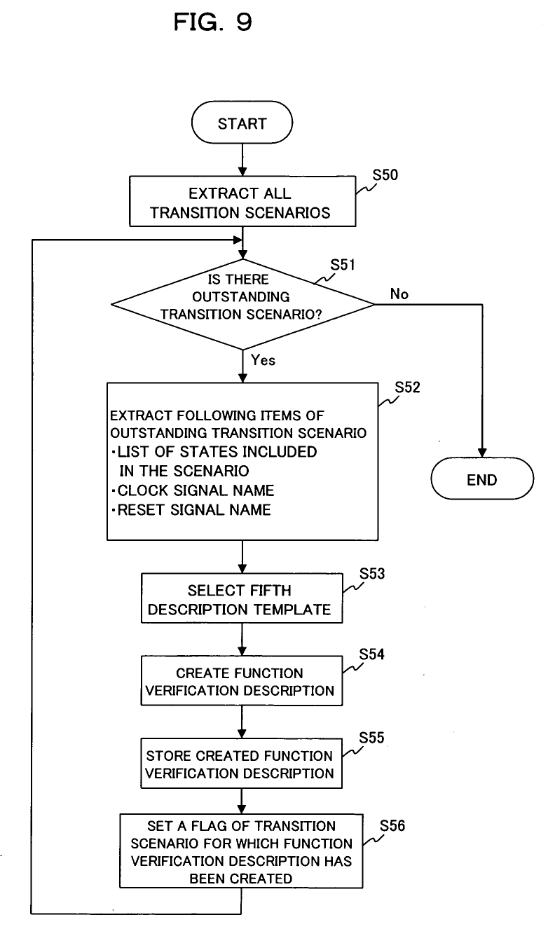

Next, description will now be made in relation to a creation of a function verification description based on the fifth description template 15 with reference to flow chart FIG. 9 (steps S50-S56).

First of all, the FSM specification data extracting section 21 of the function verification description generator 20 extracts all the predetermined scenarios, which have been input by a designer with the intension of checking the FSM, from the specification data of the FSM retained in the FSM specification memory 102 (step S50, a step of extracting).

In succession, the function verification description creating section 23 judges whether or not there is an outstanding transition scenario (step S51). Namely, the function verification description creating section 23 in this embodiment retains a creation flag for each of all the scenario extracted in step S50 to indicate whether or not the function verification description for the transition scenario in question has been created, and judges whether or not there is a transition scenario the creation flag for which is not set.

Here, if the result of judgment is negative (in other words, there is no scenario the creation flag of which is not set) (No route in step S51), the succession of the procedural steps terminate.

On the other hand, if the result of the judgment is positive (in other words, there is a transition scenario the creation flag of which is not set) (Yes route in step S51), the FSM specification data extracting section 21 extracts data (here, a list of states included in the transition scenario (a list of states rearranged in the order of transition, a clock signal name, and a reset signal name) concerning the outstanding transition scenario from the specification data (see FIG. 6) retained in the FSM specification memory 102 (step S52, a step of extracting).

In succession, the template selecting section 22 selects the fifth description template 15 from the five description templates retained in the template retaining section 10 (step S53, a step of selecting).

The function verification description creating section 23 substitutes the data extracted by the FSM specification data extracting section 21 in step S52 into the fifth description template 15 selected by the template selecting section 22 in step S53 to create a function verification description (step S54, a step of creating).

The function verification description creating section 23 stores the function verification description created in step S54 into the function verification description memory 30 (step S55), sets the creation flag concerning the predetermined transition scenario for which a function verification description has been created (step S56) and returns to step S51.

The function verification description creating section 23 repeats the above procedural steps S51 through S56 whereby creates function verification descriptions for all the transition scenarios of the specification data retained in the FSM specification memory 102.

As described above, in the function verification description creating apparatus 1 and the method for creating a function verification description according to an embodiment of the present invention, the FSM specification data extracting section 21 extracts data required for creating a function verification description for a performance that is a subject of simulation (a step of extracting), the template selecting section 22 selects a description template for a function verification description corresponding to the performance of the simulation from the description templates retained in the template retaining section 10 (step of selecting), and the function verification description creating section 23 substitutes data extracted by the FSM specification data extracting section 21 into the description template selected by the template selecting section 22 to thereby create a function verification description for the performance in question (a step of creating). In this creation manner, even if the specification data is written in a different language (i.e., to design the FSM) from that of a function verification description, a function verification description can be automatically created irrespective of these languages. Additionally, a function verification description is automatically created based on a description template, an operator without knowledge about a description language of a function verification description and a creation manner of the description language can surely create a function verification description with ease.

### (B) Others

The present invention should by no means be limited to the foregoing embodiment and various change or modification may be suggested without departing from the concept of the present invention.

For example, the above embodiment assumes that the specification data of the FSM retained in the FSM specification memory 102 of the FSM designing apparatus 100 is written in HDL and the first through the fifth description templates (i.e., function verification descriptions created by the function verification description creating section 23) are written in PSL. Description languages are not limited to these examples in the present invention and may be SVA (System Verilog Assertion) or the like.

In the foregoing embodiment, the FSM specification data extracting section 21 of the function verification description generator 20 extracts the specification data from the FSM specification memory 102 of the FSM designing apparatus 100, to which a data extraction source is not limited. Alternatively, it is sufficient that the FSM specification data extracting section 21 is accessible to a database that retains specification data required for function verification descriptions.

Further in the above embodiment, the template retaining section 10 retains the first through fifth description templates 11-15, but the present invention should by no means be limited. Alternatively, it is sufficient that the template retaining section 10 retains at least one description template that may or may not be one of the first through fifth description templates.

Namely, one or more description templates retained in the template retaining section 10 should by no means be limited to the first to fifth description templates and may be other templates associated with performances that are subjects of simulation performed on the FSM.

Functions of the FSM specification data extracting section 21, the template selecting section 22, the function verification description creating section 23 may be realized by a computer (e.g., a CPU, an information processor, and various terminals) executing a predetermined application program (a program for creating a function verification description).

Such a program is provided in the form of a computer-readable recording medium exemplified by a flexible disk, a CD (such as CD-ROM, CD-R, CD-RW), or a DVD (such as DVD-ROM, DVD-RAM, DVD-R, DVD-RW, DVD+R, DVD+RW) in which the program is recorded. In this case, the computer reads the creation program for a function verification description from the recoding medium and sends the read program to store into an internal or external memory for future use. Alternatively, the program may be previously recorded in a storage (a recording medium) exemplified by a magnetic disk, an optical disk or a magnet-optical disk, and provided to a computer from the storage through communication network.

The concept of a computer in this embodiment includes hardware and an OS (Operating System) and means hardware that operates under control of the OS. If an application program independently operates hardware, requiring no OS, the hardware itself corresponds to a computer. Hardware includes at least a microprocessor such as a CPU and means for reading a computer program recorded in a recording medium.

An application program serving as the creation program for a function verification description includes a program code that causes the computer to realize the functions of the FSM specification data extracting section 21, the template selecting section 22 and the function verification description creating section 23. Alternatively, a part of the functions may be realized by an OS, not by the application program.

Further, the recording medium used in this embodiment may be one from various computer-readable recording mediums incorporates in the form of an IC card, a ROM cartridge, a magnetic tape, a punch card, an internal memory (such as a RAM or a ROM) in a computer, an external memory, or a printed matter on which codes such as bar codes are printed, other than the above examples of a flexible disk, a CD, a DVD, a magnetic disk, an optical disk and a magneto-optical disk.

What is claimed is:

1. An apparatus for creating a function verification description which is used for verifying a result of simulation performed on a finite state machine, comprising:
an extracting section for extracting data concerning a performance that is a subject for the simulation from specification data of the finite state machine;
a retaining section for retaining one or more description templates for function verification descriptions which description templates are associated with one or more performances that are subjects for simulation;
a selecting section for selecting a particular description template corresponding to said first performance from the description templates retained in said retaining section; and
a creating section for creating the function verifying description by substituting the data concerning said first performance, which data is extracted by said extracting section, into said particular description template selected by said selecting section.

2. An apparatus for creating a function verification description according to claim 1, wherein:
the description templates retained in said retaining section includes a first description template for a function verification description used for verifying that the finite state machine progresses from a source state to a destination state under a proper condition;
said extracting section extracts a source state, a transition condition and a destination state of the finite state machine from the specification data;
said selecting section selects the first description template retained in said retaining section; and
said creating section creates the first function verification description for verifying that the finite state machine progresses from a source state to a destination state under a proper condition by substituting the source state, the transition condition and the destination state that have been extracted by said extracting section into said first description template selected by said selecting section.

3. An apparatus for creating a function verification description according to claim 2, wherein:
said extracting section extracts all states, all transition paths, and transition conditions, associated one with each of all the transition paths, from the specification data of the finite state machine; and
said creating section creates the first function verification description for each of all the transition paths extracted by said extracting section based on the first description template.

4. An apparatus for creating a function verification description according to claim 3, wherein said creating section sets a flag of a transition path for which said creating section has created the first function verification description.

5. An apparatus for creating a function verification description according to claim 3, wherein said extracting section extracts a common transition condition that is common to all the state of the finite state machine, and one or more transition paths, each of which is associated with the common transition condition, as the transition conditions associated with all the transition paths and all the transition paths, respectively.

6. An apparatus for creating a function verification description according to claim 1, wherein:
the description templates retained in said retaining section includes second description template for a second function verification description used for verifying that the finite state machine progresses from a source state to a destination state within a predetermined cycle set;
said extracting section extracts a source state, a destination state, and a predetermined transition cycle set from the specification data;
said selecting section selects the second description template retained in said retaining section; and
said creating section creates the second function verification description for verifying that the finite state machine progresses from a source state to a destination state within a predetermined cycle set by substituting the source state, the destination state and the predetermined cycle set that have been extracted by said extracting section, into the second description template selected by said selecting section.

7. An apparatus for creating a function verification description according to claim 6, wherein:
said extracting section extracts all predetermined transition cycle sets, and source states and destination states associated with all the predetermined transition cycle sets from the specification data;
said creating section creates the second function verification description for each of all the transition cycle sets extracted by said extracting section based on the second description template.

8. An apparatus for creating a function verification description according to claim 7, wherein said creating section sets a flag of a predetermined transition cycle for which said creating section has created the second function verification description.

9. An apparatus for creating a function verification description according to claim 1, wherein:
the description templates retained in said retaining section includes a third description template for a third function verification description used for verifying that the finite state machine progresses from a source state to a predetermined destination state even though routed via another state;
said extracting section extracts a source state and a destination state from the specification data based on an assignation information piece for assigning the last-named source state and the last-named destination state;
said selecting section selects the third description template retained in the retaining section; and
the creating section creates a third function verification description for verifying that the finite state machine progresses from a source state to a predetermined destination state even though routed via another state by substituting the last-named source state and the last-named predetermined destination state obtained by said extracting section into the third description template selected by said selecting section.

10. An apparatus for creating a function verification description according to claim 9, wherein:
said extracting section extracts all combinations of a source state and a predetermined destination state, each of the combinations being associated with one of all assignation information pieces;
said creating section creates the third function verification for each of all the assignation information pieces extracted by the extracting section based on the third description template.

11. An apparatus for creating a function verification description according to claim 9, wherein said creating section sets a flag of an assignation information piece for which said creating section has created the third function verification description.

12. An apparatus form creating a function verification description according to claim 1, wherein:
the description templates retained in said retaining section includes a fourth description template for a fourth function verification description used for verifying that the finite state machine progresses from a source state to a predetermined destination state;
said extracting section extracts a source state and a destination state associated with the last-named source state;
said selecting section selects the fourth description template retained in the retaining section; and
the creating section creates a fourth function verification description for verifying that the finite state machine progresses from a source state to a predetermined destination state by substituting the source state and the destination state that have been extracted by said extracting section into the fourth description template selected by said selecting section.

13. An apparatus for creating a function verification description according to claim 12, wherein:
said extracting section extracts all states of the finite state machine and predetermined destination states associated one with each of all the states from the specification data; and
said creating section creates the fourth function verification description for each of all the states extracted by said extracting section based on the fourth template.

14. An apparatus for creating a function verification description according to claim 13, wherein said creating section sets a flag of a state for which said creating section has created the fourth function verification description.

15. An apparatus for creating a function verification description according to claim 1, wherein:
the templates includes a fifth description template used for measuring a coverage of a predetermined transition scenario that executes the first-named simulation;
said selecting section selects the fifth description template retained in the retaining section; and
said creating section creates a fifth function verification description concerning the predetermined transition scenario based on the fifth description template selected by the selecting section.

16. An apparatus for creating a function verification description according to claim 15, wherein:
said extracting section extracts a list of one or more transition states from the predetermined transition scenario;
said creating section creates the fifth function verification description for measuring the coverage by substituting the list extracted by the extracting section into the fifth description template.

17. An apparatus for creating a function verification description according to claim 1, the specification data of the finite state machine is written in a different language from that of each of the description templates.

18. An apparatus for creating a function verification description according to claim 17, wherein the specification data of the finite state machine is written in HDL (Hardware Description Language) and the function verification description created by said creating section is written in PSL (Property Specification Language).

19. A method for creating a function verification description which is used for verifying a result of simulation performed on a finite state machine, comprising the steps of:
(a) extracting data concerning a performance that is a subject for the simulation from specification data of the finite state machine;
(b) selecting a particular description template corresponding to the performance from one or more description templates for function verification descriptions which description templates are associated with one or more performances that are subjects for simulation; and
(c) creating the function verifying description by substituting the data concerning the first performance, which data is extracted in said step (a) of extracting, into said particular description template selected in said step (b) of selecting.

20. A computer-readable recording medium in which a program for creating a function verification description which is used for verifying a result of simulation performed on a finite state machine, wherein said program instructs a computer to function as:
an extracting section for extracting data concerning a performance that is a subject for the simulation from specification data of the finite state machine;
a retaining section for retaining one or more description templates for function verification descriptions which description templates are associated with one or more performances that are subjects for simulation;
a selecting section for selecting a particular description template corresponding to said first performance from the description templates retained in said retaining section; and
a creating section for creating the function verifying description by substituting the data concerning said first performance, which data is extracted by said extracting section, into said particular description template selected by said selecting section.
